(19) United States
(12) Patent Application Publication
(10) Pub. No.: US 2009/0245780 A1
(43) Pub. Date: Oct. 1, 2009

(54) Shutter device

(76) Inventors: Kun-Feng Chiang, Taipei City (TW); Chao-Jung Chiang, Hsinchu City (TW); Chao-Hsi Wang, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,083

(22) Filed: Mar. 27, 2008

(51) Int. Cl. G03B 9/14

(52) U.S. Cl. 396/469

(57) ABSTRACT

A shutter device comprises a base, two electromagnetic valves, two blades, and a cover plate. A first light hole is formed in the center of base. The electromagnetic valve comprises a magnetic core, a coil unit, and a magnetic part. The magnetic cores and coil units are on the base, being axially symmetrical at the periphery of first light hole of the base. The blades join with the corresponding magnetic parts of the electromagnetic valves, in which each of the blades may travel between first and second positions at a degree of freedom to open or shut the first light hole through which rays of light pass. The cover plate is assembled onto the base and provided with a second light hole corresponding to the first light hole. The two magnetic cores are axially symmetrical on the base and lie at the periphery of first light hole.

### BACKGROUND OF THE INVENTION

1. Field of the Invention

This invention relates to a shutter device and particularly to a shutter device of a photography module provided in a hand-held mobile device or a portable computer device.

2. Description of Related Art

In recent years, an photography module provided in a mobile phone, a PDA and the like, such as hand-held mobile devices, laptop PCs or other portable computer devices, has become widespread. Thereby, smaller physical volume is required for hand-held mobile devices according to consumer markets, and thus the photography module needs to provide both higher photographic resolution and reduced volume. A conventional photography module provided in a hand-held mobile device or portable computer contains either of 2 types of common photosensors, a Charge-Coupled Device (CCD) or a Complementary Metal-Oxide Semiconductor (CMOS).

A conventional shutter device is provided in the photography module to solve issues found in the process of image exposure, and works in the principle: two shutter blades being provided for example in a CCD or CMOS as a front optical path to open/shut an electromagnetic valve (also called electromagnetic actuator) being used to open or shut the shutter blades. In the suspend mode of the camera, after the electromagnetic valve is electrified, an electromagnetic action is caused to control the shutter blade opening/shutting, thereby controlling the optical sensor being subject to the light or not for achievement of exposure control; for example, the shutter device in such a principle described in Chinese Patent No. CN1503046A.

However, in pursuit of a thin, slim, small product in today's consumer market, the available space for components in hand-held mobile devices or portable computers becomes increasingly narrow, the photography module must be miniaturized, and thus the shutter device must also be miniaturized and adopt a thin physical volume. Thus, to design the miniaturized and thin shutter device of which requirements of functions meet what manufacturers want is an object and task implemented by related researchers and manufacturers.

Consequently, because of the technical defects of described above, the applicant keeps on carving unflaggingly through wholehearted experience and research to develop the present invention, which can effectively improve the defects described above.

### SUMMARY OF THE INVENTION

The objective of this invention is to provide a miniaturized and thin shutter device.

For the characteristics of this invention, the shutter device is provided, comprising a base of which the center is formed with a first optical hole; two electromagnetic valves each of which comprises a magnetic core, a coil unit, and a magnetic part, in which the coil unit is wound around the magnetic core are grouped, the magnetic core is formed with two ends, the magnetic part may be rotationally provided on the base, the magnetic core and coil units of the two electromagnetic valves are symmetrically provided on the base around the periphery of first light hole of the base, one of the end of the magnetic core of each of the electromagnetic valves corresponding to the magnetic part of the electromagnetic valve, and the other end of the magnetic coil of each of the electromagnetic valve is corresponding to the magnetic part of the other electromagnetic valve; two blades joining together with the corresponding magnetic part of the electromagnetic valve, in which each of the blades may travel between first and second positions at a degree of freedom to open or shut a first light hole through which rays of light pass; and a cover plate connected to the base and formed with a second light hole corresponding to the first light hole of the base, in which each of the blades lies between the base and the cover plate. The magnetic coil and coil unit of the two electromagnetic valves are used to generate an electromagnetic field. The magnetic forces generated by the two electromagnetic fields and the magnetic parts of two electromagnetic valves interact each other so as to generate two electromagnetic thrusts together. The two electromagnetic thrusts push the magnetic parts of the two electromagnetic valves to run so that the two blades may travel between the first and second positions to open or shut the first light hole through which the rays of light pass.

Regarding the advantage of this invention, the two magnetic cores are symmetrically provided on the base and lie around the periphery of the first light hole, thereby reducing the physical volume of shutter device for achievement of miniaturization.

Further, in this invention, the two electromagnetic valves that are meanwhile electrified may push the two blades to run in the meantime; namely, when only one electromagnetic valve is electrified, the affiliated blade cannot run, which prevents lack of expected exposure because the blades separately runs after the single one electromagnetic valve is electrified.

Besides, the two magnetic cores may be an externally symmetrical member. After the two electromagnetic valves are electrified, an even thrust is generated and the two blades is made to work synchronously for prevention of exposure time from being impacted due to a fact that one shutter is fast and the other shutter is slow.

In order to further understand the technical means and effects adopted to achieve the objectives of this invention, please refer to the detailed description and accompanied drawings according to this invention. It is believed that the objectives, features, and points of this invention will be apparent from the description; however, the accompanied drawings are provided for reference and illustration only and not intended to limit the terms or scope of this invention.

### BRIEF DESCRIPTION OF THE DRAWINGS

FIG. 1 is a 3D assembly drawing of this invention;

FIG. 2 is a 3D exploded view of this invention;

FIG. 3 is a assembly top view of this invention;

FIG. 4 is a view of a section 4-4 of FIG. 3;

FIG. 5 is a top view (1) of this invention, in which a cover plate and a spacer are removed; and

FIG. 6 is a top view (2) of this invention, in which the cover plate and the spacer are removed.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

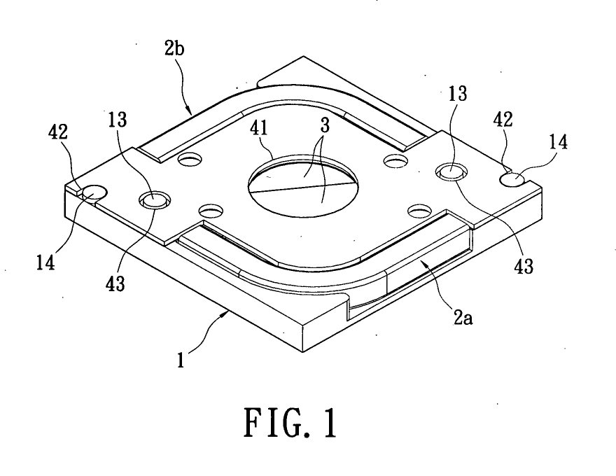

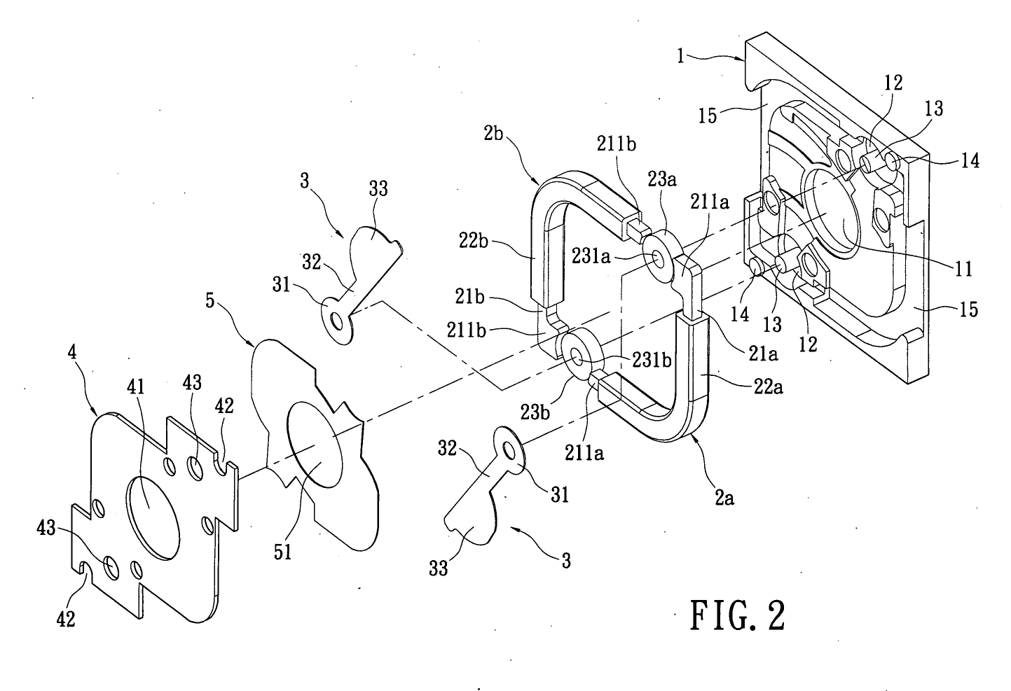

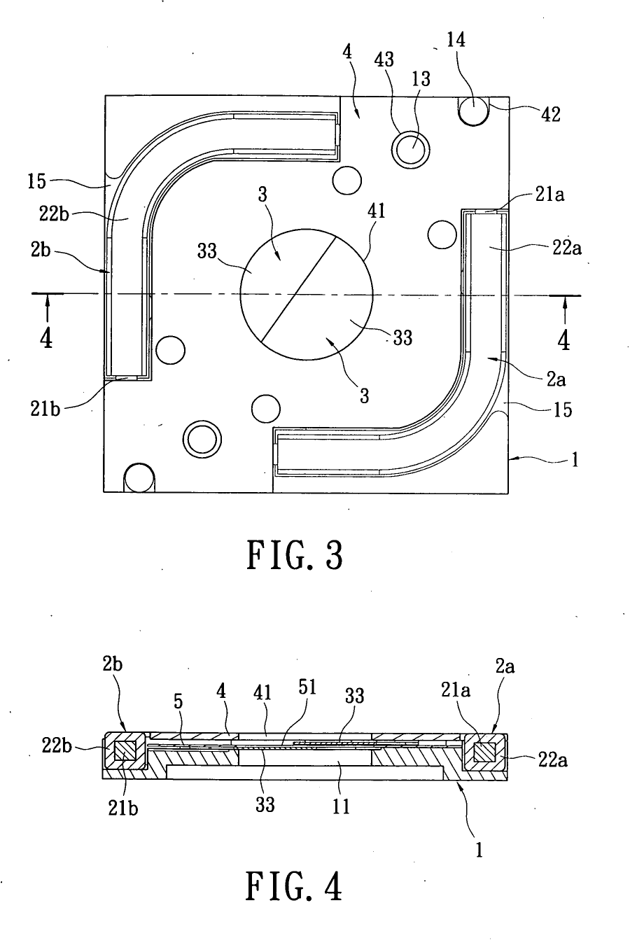

With reference to FIGS. 1 through 4, a shutter device according to this invention is provided in an photography module of a hand-held mobile device or a portable computer device. The shutter device comprises a base 1, two electromagnetic valves 2a and 2b, two blades 3, and a cover plate 4.

The base 1 is a cube of which the center is formed with a first light hole 11. Two cavities 12 are formed at two sides of the base 1 that are opposite to each other. A pivot pillar 13 protrudes from a bottom wall of each of the cavities 12. Besides, a plurality of fixing pillars 14 are provided at a top side of the base 1, and two accommodation grooves 15 may be formed at the periphery of the first light hole 11 symmetrically at two diagonal corners of the base, thereby forming the base 1.

Each of the two electromagnetic valves 2a and 2b comprises magnetic cores 21a and 21b, coil units 22a and 22b, and magnetic parts 23a and 23b, in which the coil units 22a and 22b are wound around the magnetic core 21a and 21b and have two ends 211a and 211b which are yokes of the magnets, and preferably the magnetic parts 21a and 21b of the two electromagnetic valves 2a and 2b are externally symmetrical members. In this invention, the two magnetic cores 21a and 21b are slightly in a shape of L. The magnetic parts 23a and 23b of the two electromagnetic valves 2a and 2b are cylindrical loadstones each of which are formed with a pivot hole 231a and 231b. Certainly, the two magnetic parts 23a and 23b may be also another cylindrical magnetic part.

Two blades 3 are symmetrical plates each of which comprises a round base 31, a link arm 32 stretching from the base 31, and a covering part 33 connected to the link arm 32.

The cover plate 4 is a lamella part of which the center is formed with a second light hole 41, and is provided with a plurality of fixing holes 42 and through holes 43 at the periphery of second light hole 41.

Further, in this invention, it may comprises a spacer 5 of which the center is formed with a third light hole 51.

The magnetic parts 23a and 23b of the two electromagnetic valves 2a and 2b may be provided that is rotational in the corresponding cavities 12 of the base 1. The pivot pillars 13 are made to pivot in the pivot holes 231a and 231b, thereby making the magnetic parts 23a and 23b rotational on the base 1. The magnetic cores 21a and 21b and coil units 22a and 22b of the two electromagnetic valves 2a and 2b are symmetrically provided on the base 1 and at the periphery of first light hole 11 of the base 1; preferably, they are provided symmetrically on the base 1 at diagonally opposite corners and accommodated in the corresponding grooves 15 of the base 1.

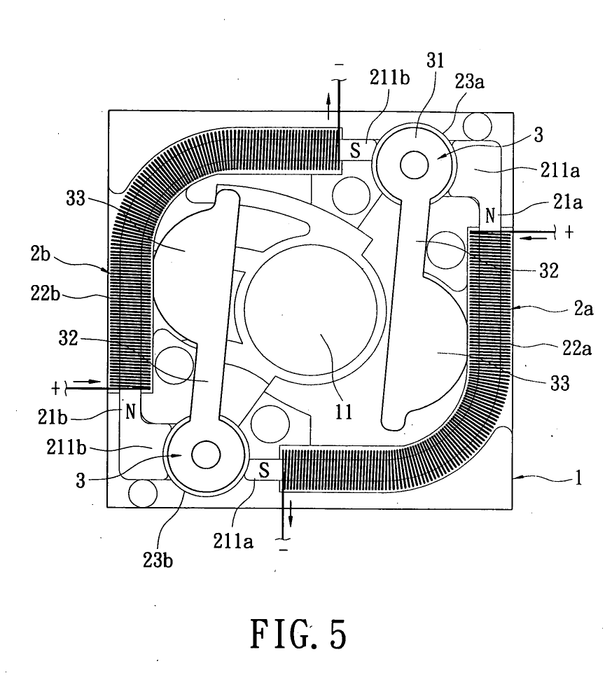

The ends 211a and 211b of the magnetic cores 21a and 21b of the electromagnetic valves 2a and 2b are corresponding to the magnetic parts 23a and 23b of the affiliated electromagnetic valves 2a and 2b, and the ends 211a and 2111b of the magnetic cores 21a and 21b of the electromagnetic valves 2a and 2b are corresponding to the magnetic parts 23a and 23b of the electromagnetic valves 2a and 2b; namely, the magnetic parts 23a and 23b are corresponding to the ends 211a and 211b of the two magnetic cores 21a and 21b, as shown in FIG. 5.

The two blades 3 link with the corresponding magnetic parts 23a and 23b of the electromagnetic valves 2a and 2b to make the magnetic parts 23a and 23b and the two blades 3 rotational and synchronous with each other. The rotational magnetic parts 23a and 23b may travel between first and second positions at a degree of freedom to open or shut a first light hole 11 through which rays of light pass. In this invention, the bases 31 of the two blades 3 may be adhered and thus fixed onto the corresponding magnetic parts 23a and 23b so that the covering parts 33 of the two blades 3 may travel between the first and second positions at the degree of freedom to open or shut the first light hole 11 through which the rays of light pass. Certainly, in another structure that is possibly designed, the magnetic parts 23a and 23b and the blades 3 are rotational and work with each other.

The cover plate 4 is combined into the base 1. Each rivet hole 42 of the cover plate 4 may associate with a rivet pillar 14 corresponding to the base 1 so as to fix the cover plate 4 onto the base 4. Each blade 3 lies between the cover plate 4 and the base 1 and the second light hole 41 of cover plate 4 is corresponding to the first light hole 11 of the base 1. The end of pivot pillar 13 of the base 1 may stretch into the through hole 43 corresponding to the cover plate 4. The base 1 is installed and combined with the parts. Certainly, according to requirements, other members and functional parts may be installed but not limited in this invention.

The spacer 5 is provided between the two blades 3 to separate the two blades 3 from each other up and down, as shown in FIG. 4. The third light hole 51 of spacer 5 is corresponding to the first light hole 11 of base 1 and the second light hole 41 of cover plate 4 to form an optical path for image exposure.

Thus, in this invention, what is further described below is the co-operation of the two blades 3 with the two electromagnetic valves 2a and 2b. When the coil units 22a and 22b of the two electromagnetic valves 2a and 2b are electrified in the meantime, the two coil units 22a and 22b work with the two magnetic cores 21a and 21b to generate an electromagnetic field. Magnetic forces generated by the two electromagnetic fields and the magnetic parts 23a and 23b of two electromagnetic valves interact each other so as to generate two electromagnetic thrusts together. The two electromagnetic thrusts commonly push the magnetic parts 23a and 23b of the two electromagnetic valves 2a and 2b to run and then drive the two blades 3 so that the covering parts 33 of the two blades 3 may travel between the first and second positions to open or shut the first light hole 11 through which the rays of light pass.

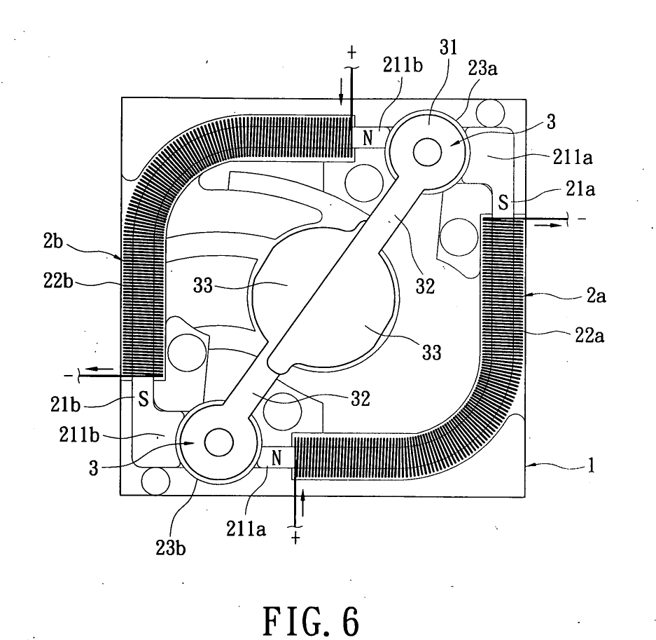

Further, refer to FIGS. 5 and 6. According to the Ampere right hand rule, when the two coil units 22a and 22b are electrified, positive and negative DC voltages make the coil units 22a and 22b and the magnetic cores 21a and 21b generate electromagnetic fields of N and S poles, and the N and S poles of the magnetic parts 23a and 23b interact each other to generate the electromagnetic thrust, thereby making the two magnetic parts 23a and 23b run clockwise or counter-clockwise. Thus, as long as the positive and negative DC voltages applied to the two terminals of coil units 22a and 22b are controlled and adjusted, the covering parts 33 of the two blades 3 may travel between the first and second positions to open or shut the first light hole 11 and then open or shut the optical path for image exposure; for example, when the two blades 3 are at the first travel position, the optical path is open, as shown in FIG. 5, and contrarily, when they are at the second travel position, the optical path is close, as shown in FIG. 6. The spacer 5 may be used to prevent the two blades 3 that are traveling from interfering with each other or being blocked for keeping the requirements of the two blades 3. However, according to the requirements, the spacer 5 is installed between the two blades 3 for achievement of the object; certainly, the spacer 5 is optional or another design may be brought for achievement of the identical object. Preferably, the spacer 5 is used because the performance of shutter might be lower in another manner.

From the description above, the two magnetic cores 21a and 21b are provided symmetrically on base 1 and lie at the periphery of the first light hole 11, and thereby only the first light hole 11 may be provided in the center of base 1. Thus, the physical volume of the shutter device is advantageously reduced and the device becomes thinner. Furthermore, an accommodation groove 15 is formed concave on the base 1 for the two magnetic cores 21a and 21b and the coil units 22a and 22b, and a cavity 12 is formed for the two magnetic parts 23a and 23b, the physical volume of shutter device being thereby reduced.

Next, in this invention, the two electromagnetic valves 2a and 2b that are meanwhile just electrified may push the two blades 3 to run in the meantime; namely, when only one electromagnetic valve 2a or 2b is electrified, the affiliated blade 3 cannot run, which prevents lack of expected exposure because the blades 3 separately run after the single one electromagnetic valve 2a or 2b is electrified.

Besides, the two magnetic cores 21a and 21b are externally symmetrical members. When the two electromagnetic valves 2a and 2b are electrified, an even electromagnetic thrust is generated to make the two blades 3 synchronous in running for prevention of exposure time from being impacted due to a fact that one shutter is fast and the other shutter is slow.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shutter device, comprising:
a base, the center of which is formed with a first light hole for the passage of light;
two electromagnetic valves each of which comprises a magnetic core, a coil unit, and a magnetic part, in which the coil unit is wound around the magnetic core, the magnetic core is formed with two ends, the magnetic part may be rotatingly provided on the base, the magnetic core and the coil unit of the two electromagnetic valves are symmetrically provided on the base at the periphery of the first light hole of the base, one of the ends of the magnetic core of each of the electromagnetic valves corresponds to the magnetic part of the electromagnetic valve, and the other end of the magnetic coil of each of the electromagnetic valve corresponds to the magnetic part of the other electromagnetic valve;
two blades joining together with the corresponding magnetic part of the electromagnetic valve, in which each of the blades may travel between first and second positions at a degree of freedom to open or shut the first light hole; and
a cover plate connected to the base and formed with a second light hole corresponding to the first light hole of the base, in which each of the blades lies between the base and the cover plate;
The magnetic coil and coil unit of the two electromagnetic valves being used to generate an electromagnetic field; the magnetic forces generated by the two electromagnetic fields and the magnetic parts of two electromagnetic valves interacting with each other so as to generate two electromagnetic thrusts; the two electromagnetic thrusts pushing the magnetic parts of the two electromagnetic valves to run so that the two blades may travel between the first and second positions to open or shut the first light hole.

2. The shutter device according to claim 1, wherein the magnetic cores of the two electromagnetic valves are a pair of externally symmetrical members and axially symmetrical at an inclined opposite angle.

3. The shutter device according to claim 2, wherein two concave accommodation grooves are formed at the periphery of first light hole of the base and axially symmetrical on the base at an inclined opposite corners, and the magnetic coils and coil units of the two electromagnetic valves are provided in the corresponding accommodation grooves.

4. The shutter device according to claim 1, wherein two cavities are formed at two sides of the base that are opposite to each other, a pivot pillar protrudes from a bottom wall of each of the cavities, and the magnetic cores of the two electromagnetic valves are accommodated in the corresponding cavities, each of which is formed with a pivot hole to which the pivot pillar is pivoted.

5. The shutter device according to claim 1, further comprising a spacer provided between the two blades and formed with a third light hole corresponding to the first and second light holes.
